(19) United States
(12) Patent Application Publication
(10) Pub. No.: US 2003/0120567 A1
(43) Pub. Date: Jun. 26, 2003

(54) System for and method of application currency conversion

(76) Inventor: Lee Macklin, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 10/027,883

(22) Filed: Dec. 21, 2001

(51) Int. Cl. G06F 15/163; G06F 9/54; G06F 9/00; G06F 17/60

(52) U.S. Cl. 705/35

(57) ABSTRACT

The present invention is directed to a system for, a method of, and a software routine for providing real or near-real time monetary conversions. The present invention includes a program interface to an application program from which a first and second monetary unit is obtained as well as a monetary amount in the first monetary unit. A communications interface uses the received information to obtain an up-to-date conversion factor and a calculation module converts the monetary amount in the first monetary unit to a monetary amount in the second monetary unit. This monetary amount in the second monetary unit is the supplied to the requesting application program.

### TECHNICAL FIELD

The present invention generally relates to software that performs currency conversions and more specifically to a software module that may be incorporated into or accessed by other software programs to perform currency conversion.

### BACKGROUND

In today's global economy an increasing number of businesses are expanding the sales of their products and services outside their home country. This expansion is often enhanced by the Internet and similar electronic communication networks. In purchases between citizens of different countries, or between retailers in different countries, conversions between currencies of the different countries impact the ease or difficulty of consummating a pending transaction.

Several approaches are available to solve currency conversion problems. One method of currency conversion used today entails the determination, storage, and use of an appropriate conversion rate. While rates may fluctuate rapidly, a single representative rate may be obtained and used for all conversions during a specific time period. For example, a company based in the United States selling products to a company in Germany may obtain a conversion between United States dollars and German Deutsche marks on the first of the month and apply that conversion factor throughout the month. While this conversion factor may not accurately reflect the actual exchange rate at the time of a purchase later in the month, the parties use the stored conversion rate to simplify the transaction. Many companies also believe that, over time, those inaccuracies will be balanced out between the parties.

These problems are further expanded if the same U.S. company also sells, or purchases, products from companies or individuals in multiple foreign countries. For example, a U.S. based company who sells their products in Germany, Italy, Australia, Denmark, Egypt and the United Kingdom would need to maintain conversion or exchange rates between United States dollars and Deutsche marks, Italian lira, Australian dollars, Denmark krones, Egyptian pounds and United Kingdom pounds. As the number of customers or suppliers in foreign countries increases, the problem is exasperated.

Similarly, when a native of one country visits a foreign country, he or she typically consummates their purchases in the currency of the foreign country. For example, a United States citizen traveling to Japan would transact their purchases in yen. Typically, the United States citizen determines the cost of their purchases by converting the asking price of the item to United States dollars. This conversion requires use of a calculator or a simplified conversion using round numbers. This conversion process is especially difficult when price negotiations are undertaken. Additionally, when the United States citizen traveling in Japan attempts to convert United States dollars into Japanese yen, a plethora of conversion rates are available. The hotel may offer one conversion rate, individual banks may offer other rates, local American Express offices may offer still different rates, and each retailer may offer additional conversion rates to the consumer. Similar problems occur in other foreign countries with other foreign currencies.

Accordingly, a need exists for a system and method to support conversion between various currency standards.

### SUMMARY OF THE INVENTION

The present invention is directed to a software routine stored on a computer readable media including a program interface, a communications interface and a calculation module. The program interface of the present invention may interface to an application program configured to accept first and second monetary units and a monetary amount in the first monetary unit. The program interface may also provide a monetary amount associated with the second monetary unit to the application program. The communications interface may be configured to retrieve conversion information from the first monetary unit to the second monetary unit. This conversion information may be used by the calculation module to convert the monetary amount associated with the first monetary unit to a corresponding monetary amount associated with the second monetary unit.

### BRIEF DESCRIPTION OF THE DRAWINGS

FIG. 1 is a block diagram of one embodiment of the present invention; and

FIG. 2 is a flow chart depicting a preferred embodiment of the present invention.

### DETAILED DESCRIPTION

The current invention receives an input, including first and second monetary units and a monetary amount in the first monetary unit, from an application program and returns a corresponding monetary amount in the second monetary unit. The current invention includes a program interface to interface to, and from, the application program, a communication interface and a calculation module. The present invention may also include a software routine that acts as an interface between the program interface, communications interface and the calculation module. The communications interface uses the first and second monetary units received from the application program to retrieve a conversion or exchange rate from an electronic source for converting from the first monetary unit to the second monetary unit. The calculation module applies this conversion rate to the monetary amount in the first monetary unit to determine a monetary amount in the second monetary unit. An alternate embodiment of the present invention is a hand held device that uses wireless communication to receive real-time conversion information for use in conversions requested by, for example, a traveler.

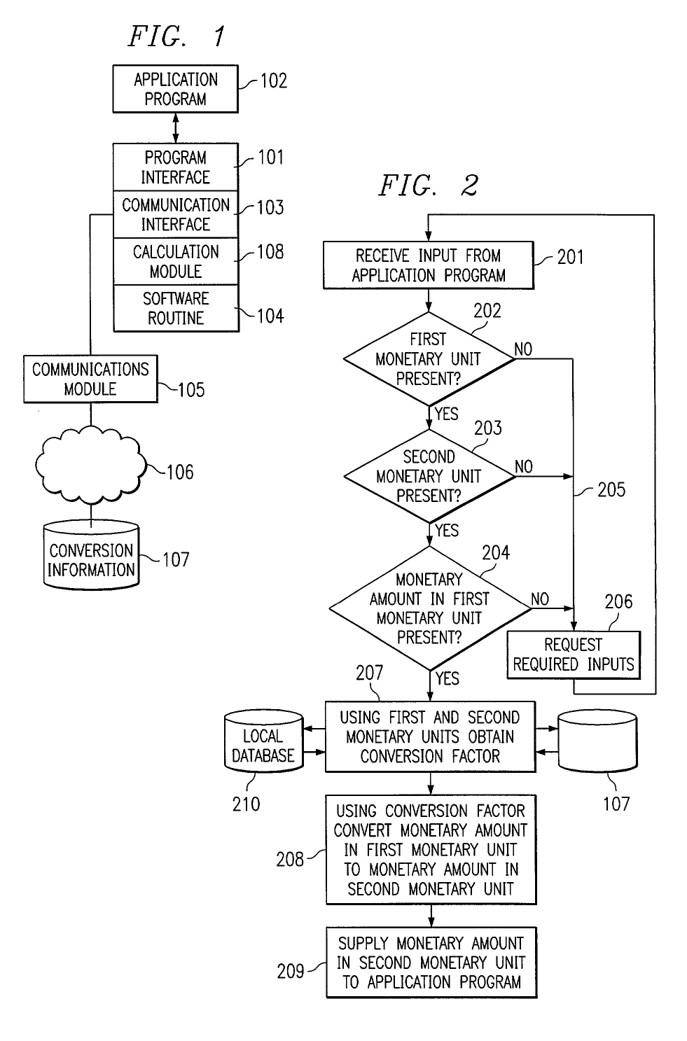

FIG. 1 shows one embodiment of the present invention. Program Interface 101 interfaces with Application Program 102 to obtain the parameters necessary to configure and compute the conversion. In a preferred embodiment of the present invention Application Program 102 provides first and second monetary units and a monetary amount in the first monetary unit. Application Program 102 may be, for example, a financial program that provides monetary units, such as U.S. Dollars and Japanese Yen, along with a value for an amount of U.S. Dollars.

Program Interface 101 provides the information received from Application Program 102, directly, or by interfacing with Software Routine 104, to Communication Interface 103. Communication Interface 103, accesses a Communications Module 105, such as a web server, to access Internet 106. This connection may be partially or entirely wireless. Through the access to Internet 106, Communication Interface 103 accesses Remote Database 107, which includes up-to-date conversion factors for monetary units or currency. Using the first monetary unit and the second monetary unit received from Application Program 102, Communication Interface 103 accesses the appropriate conversion factor or exchange rate to convert a monetary amount in the first monetary unit to a corresponding monetary amount in the second monetary unit.

Calculation Module 108, using the appropriate conversion factor, converts the monetary amount in the first monetary unit to a monetary amount in the second monetary unit. One of ordinary skill in the art would understand that Program Interface 101 may supply a monetary amount in the first monetary unit, the first monetary unit and the second monetary unit directly to Calculation Module 108. Calculation Module 108 may then supply the first and second monetary units to the communication interface for obtaining the appropriate conversion factor. Alternatively, Software Routine 104 may provide all necessary communications between Program Interface 101, Communication Interface 103 and Calculation Module 108.

Once a monetary amount in the second monetary unit is calculated, Program Interface 101 provides the second monetary amount to Application Program 102. One of ordinary skill would further understand that Communications Interface 103 may be configured to access a single site, or multiple sites. Communication Interface 103 may also be configured to access multiple sites and select the most current or most favorable conversion rate. One of ordinary skill would also appreciate that the calculations may be performed at the remote site with the second monetary unit being communicated to Communications Interface 103.

FIG. 2 is a flow chart of a method according to a preferred embodiment of the present invention. In step 201, the program interface (101 of FIG. 1) receives the appropriate input, including a numeric monetary amount in a first monetary unit, and a first and a second monetary unit from an application program. Steps 202, 203 and 204 ensure that each of the required parameters, first monetary unit (step 202), second monetary unit (step 203) and a monetary amount in the first monetary unit (step 204) are present. If one or more of these required parameters are missing, the control of the flow is returned, via 205 and step 206 to receive input step 201. In this case, step 206 reminds the user or the application program of the required parameters. If all three required parameters are present, step 207 uses the first and second monetary unit information to access database 107 to obtain a conversion factor.

In step 208 the conversion factor is applied to the monetary amount in the first monetary unit to calculate a monetary amount in the second monetary unit. Step 209 provides the calculated monetary amount to Application Program 102 (FIG. 1). Alternatively, the present invention may include its own database 210 for conversion factors which are dynamically updated to ensure up-to-the-date values are available when necessary. The storage of these values would ensure conversions even when outside database 107 is unavailable.

One of ordinary skill in the art would understand that the present invention may be programmed as a dynamic link library (i.e., dll) or a command (i.e., .com) file which interacts with application programs to return the appropriate monetary amount. The communications server may communicate with a remote server each time a conversion is requested, or may store plural conversion factors for a predefined period of time. This period of time may be, for example, on the order of minutes, hours or days. The communication interface may include a web browser and may use hypertext protocol (HTTP) to communicate.

First and second monetary units may be any currency type as long as the first monetary unit is not equal to, or the same as, the second monetary unit. One of ordinary skill in the art would understand that a monetary amount in the first monetary unit is typically multiplied by the conversion factor to determine the monetary amount in the second monetary unit. Alternatively, the monetary amount of the first monetary unit may be divided by a conversion factor from the second monetary unit to determine the monetary amount in the second monetary unit.

What is claimed is:

1. A software routine stored on a computer readable media comprising:
a program interface to an application program configured to accept first and second monetary units and a monetary amount associated with said first monetary unit from said application program;
a communications interface configured to retrieve conversion information from said first monetary unit to said second monetary unit;
a calculation module configured to convert said monetary amount associated with said first monetary unit to a corresponding monetary amount associated with said second monetary unit based on said conversion information; and
wherein said program interface is further configured to provide said monetary amount associated with said second monetary unit to said application program.

2. The software routine stored on a computer readable media of claim 1 further comprising storage for storing said software routine within a dynamic link library.

3. The software routine stored on a computer readable media of claim 1 wherein said communications interface is configured to communicate with a remote server.

4. The software routine stored on a computer readable media of claim 1 wherein said communications interface comprises a web browser.

5. The software routine stored on a computer readable media of claim 1 wherein said communications interface implements hypertext transfer protocol for communicating with a remote web server.

6. The software routine stored on a computer readable media of claim 1 wherein said first monetary unit is United States dollars and said second monetary unit is a foreign currency.

7. The software routine stored on a computer readable media of claim 1 wherein said conversion information includes an exchange rate from said first monetary unit to said second monetary unit and said calculation module is configured to multiply said monetary amount associated with said first monetary unit by said exchange rate to provide said monetary amount associated with said second monetary unit.

8. The software routine stored on a computer readable media of claim 1 further comprising a web client configured to obtain said conversion information from a remote server.

9. A method of converting between a first and a second monetary unit comprising the steps of:
accepting first and second monetary units and a monetary amount associated with said first monetary unit from an application program;
retrieving conversion information from said first monetary unit to said second monetary unit through a communications interface;
converting said monetary amount associated with said first monetary unit to a corresponding monetary amount associated with said second monetary unit based on said conversion information; and
providing said monetary amount associated with said second monetary unit to said application program.

10. The method of converting of claim 9 wherein said steps of accepting, retrieving, converting and providing are in a dynamic link library.

11. The method of converting of claim 9 further comprising a step of communicating with a remote server.

12. The method of converting of claim 9 further comprising a step of executing a web browser.

13. The method of converting of claim 9 wherein said step of retrieving includes communicating with a remote web server using hypertext transfer protocol.

14. The method of converting of claim 9 wherein said first monetary unit is United States dollars and said second monetary unit is a foreign currency.

15. The method of converting wherein said conversion information includes an exchange rate from said first monetary unit to said second monetary unit and said calculation module is configured to multiply said monetary amount associated with said first monetary unit by said exchange rate to provide said monetary amount associated with said second monetary unit.

16. A system for converting between monetary units comprising:
a program interface to an application program configured to accept first and second monetary units and a monetary amount associated with said first monetary unit;
a communications interface configured to retrieve conversion information from said first monetary unit to said second monetary unit;
a calculation module configured to convert said monetary amount associated with said first monetary unit to a corresponding monetary amount associated with said second monetary unit based on said conversion information; and
wherein said program interface is further configured to provide said monetary amount associated with said second monetary unit to said application program.

17. The system for converting of claim 16 wherein said software routine is stored within a dynamic link library.

18. The system for converting of claim 16 wherein said communications interface is configured to communicate with a remote server.

19. The system for converting of claim 16 wherein said communications interface comprises a web browser.

20. The system for converting of claim 16 wherein said communications interface implements hypertext transfer protocol for communicating with a remote web server.
